(19) United States
(12) Patent Application Publication
(10) Pub. No.: US 2025/0181345 A1
(43) Pub. Date: Jun. 5, 2025

(54) MEMORY SYSTEMS, OPERATION METHODS THEREOF, READABLE STORAGE MEDIA, AND SYSTEMS

(71) Applicant: YANGTZE MEMORY TECHNOLOGIES CO., LTD., Wuhan (CN)

(72) Inventor: Liang HE, Wuhan (CN)

(21) Appl. No.: 18/634,701

(22) Filed: Apr. 12, 2024

(30) Foreign Application Priority Data
Nov. 30, 2023 (CN) 202311647171.9

(51) Int. Cl. G06F 8/654

(52) U.S. Cl. CPC G06F 8/654

(57) ABSTRACT

Examples of the present application provide memory systems, methods of operating the memory systems, readable storage media, and systems. An example memory system includes a memory device and a memory controller coupled with the memory device. The memory device include a first memory region and a second memory region different from the first memory region. The memory controller is configured to run second firmware stored in the second memory region when first firmware stored in the first memory region fails to be run and replace the first firmware stored in the first memory region with the second firmware. The first firmware is firmware that is to be run by the memory system after firmware upgrade, and the second firmware is firmware that is normally run by the memory system before the firmware upgrade.

### CROSS-REFERENCE TO RELATED APPLICATIONS

The present application claims the benefit of priority to China Application No. 202311647171.9, filed on Nov. 30, 2023, the content of which is incorporated herein by reference in its entirety.

### TECHNICAL FIELD

Examples of the present application relate to the field of semiconductor technologies, and in examples to memory systems, operation methods thereof, readable storage media, and systems.

### BACKGROUND

With the progress of science and technology and the rapid development of the Internet, the security needs of people for storing, maintaining and transmitting information data are particularly urgent, especially in the field of memory systems. If firmware (FW) is corrupted or the firmware is upgraded with a new fault during the running of a memory system, the memory system is at risk of losing data. Therefore, the firmware is crucial to the memory system, and the prerequisite to ensure data security is to ensure the security of the firmware.

### SUMMARY

Examples of the present application provide memory systems, operation methods thereof, readable storage media, and systems.

In a first aspect, examples of the present application provide a memory system. The memory system may include a memory device and a memory controller. The memory device may include a first memory region and a second memory region different from the first memory region. The memory controller is coupled with the memory device and configured to run second firmware stored in the second memory region when first firmware stored in the first memory region fails to be run. The first firmware is firmware that is to be run by the memory system after firmware upgrade, and the second firmware is firmware that is normally run by the memory system before the firmware upgrade. The memory controller is further configured to replace the first firmware stored in the first memory region with the second firmware.

In some examples, the memory controller is configured to send an asynchronous event when the first firmware stored in the first memory region fails to be run. The asynchronous event includes at least a reason why the first firmware fails to be run after reboot.

In some examples, the memory controller is configured to replace the second firmware stored in the second memory region with the first firmware when the first firmware stored in the first memory region is run successfully.

In some examples, the memory controller is configured to obtain a firmware running state of the memory system after the memory system is rebooted. The memory controller is configured to update the firmware running state from a first state to a second state and run the first firmware in the first memory region when the firmware running state is in the first state. The memory controller is further configured to update the firmware running state from the second state to the first state and update the second firmware stored in the second memory region with the first firmware when the first firmware is run successfully.

In some examples, the memory controller is configured to keep the firmware running state in the second state when the first firmware fails to be run. The memory controller is configured to re-obtain the firmware running state of the memory system after the memory system is rebooted again. The memory controller is configured to run the second firmware of the second memory region when the firmware running state is in the second state. The memory controller is configured to update the firmware running state from the second state to the first state and update the first firmware stored in the second memory region with the second firmware when the second firmware of the first memory region is run successfully.

In some examples, the memory device includes a plurality of memory blocks, and the second memory region is located in a memory block of the memory blocks that is configured to store code data.

In some examples, the memory controller is configured to update the second firmware stored in the first memory region to the first firmware before the first firmware is run, and send an error message when the update with the first firmware in the first memory region fails. The error message indicates an error state that the first firmware fails to be activated.

In some examples, the second firmware is stored in the first memory region before the update with the first firmware in the first memory region is successful. The memory controller is configured to update the second firmware in the first memory region with the first firmware through a high-speed serial computer extended bus PCIe.

In a second aspect, examples of the present application provide a method of operating a memory system. The method includes running second firmware stored in a second memory region in a memory device of the memory system when first firmware stored in a first memory region in the memory device fails to be run, and replacing the first firmware stored in the first memory region with the second firmware. The first firmware is firmware that is to be run by the memory system after firmware upgrade. The second firmware is firmware that is normally run by the memory system before the firmware upgrade. The first memory region is different from the second memory region.

In some examples, the method further includes sending an asynchronous event when the first firmware stored in the first memory region fails to be run. The asynchronous event comprises at least a reason why the first firmware fails to be run after reboot.

In some examples, the method further includes replacing the second firmware stored in the second memory region with the first firmware when the first firmware stored in the first memory region is run successfully.

In some examples, the method further includes obtaining a firmware running state of the memory system after the memory system is rebooted. The method further includes updating the firmware running state from a first state to a second state and running the first firmware in the first memory region when the firmware running state is in the first state. The method further includes updating the firmware running state from the second state to the first state and updating the second firmware stored in the second memory region with the first firmware when the first firmware is run successfully.

In some examples, the method further includes keeping the firmware running state in the second state when the first firmware fails to be run. The method further includes re-obtaining the firmware running state of the memory system after the memory system is rebooted again. The method further includes running the second firmware of the second memory region when the firmware running state is in the second state, and updating the firmware running state from the second state to the first state and updating the first firmware stored in the second memory region with the second firmware when the second firmware of the first memory region is run successfully.

In some examples, the memory device may include a plurality of memory blocks, and the second memory region is located in a memory block of the memory blocks that is configured to store code data.

In some examples, the method further includes updating the second firmware stored in the first memory region to the first firmware before the first firmware is run. The method further includes sending an error message when the update with the first firmware in the first memory region fails. The error message indicates an error state that the first firmware fails to be activated.

In some examples, the second firmware is stored in the first memory region before the update with the first firmware in the first memory region is successful. The method further includes updating the second firmware in the first memory region with the first firmware through a PCIe.

In a third aspect, examples of the present application provide a readable storage medium, having a computer program stored therein which, when being executed, implements the method of operating the memory system of any one of the examples of the second aspect.

In a fourth aspect, examples of the present application provide a system. The system includes a host and a memory system coupled with the host. The host is configured to send a firmware upgrade command to the memory system. The memory system is configured to in response to the firmware upgrade command, run second firmware stored in a second memory region of the memory system when first firmware stored in a first memory region of the memory system fails to be run. The first firmware is firmware that is to be run by the memory system after firmware upgrade, and the second firmware is firmware that is normally run by the memory system before the firmware upgrade. The memory system is further configured to replace the first firmware stored in the first memory region with the second firmware, send an asynchronous event when the first firmware stored in the first memory region fails to be run, and replace the second firmware stored in the second memory region with the first firmware when the first firmware stored in the first memory region is run successfully. The asynchronous event includes at least a reason why the first firmware fails to be run after reboot.

In some examples, the host is configured to download the first firmware from a server and send the downloaded first firmware to the memory system before the memory system runs the first firmware. The memory system is configured to activate the first firmware, and update with the first firmware in the first memory region when the first firmware is successfully activated, and send an error message to the host when the first firmware fails to be activated. The error message indicates an error state that the first firmware fails to be activated.

### BRIEF DESCRIPTION OF THE DRAWINGS

FIG. 1 is a flow diagram of firmware update of a memory system.

FIG. 2 is a schematic diagram of a structure and a working mode of firmware update of a memory system.

FIG. 3 is a schematic diagram of a structure and a working mode of firmware update of an SSD.

FIG. 4A is a schematic diagram of a structure and a working mode of firmware update of an example memory system according to an example of the present application.

FIG. 4B is a schematic diagram of a structure and a working mode of firmware update of an example SSD according to an example of the present application.

FIG. 5 is a schematic diagram of an example system having a memory system according to an example of the present application.

FIG. 6A is a schematic diagram of an example memory card having a memory system according to an example of the present application.

FIG. 6B is a schematic diagram of an example solid-state drive having a memory system according to an example of the present application.

FIG. 7 is a schematic diagram of an example structure having a memory system provided by an example of the present application.

### DETAILED DESCRIPTION

The technical solutions in examples of the present application will be described below clearly and completely in conjunction with the examples and the drawings of the present application. Apparently, the examples described are only part of, but not all of, the examples of the present application. All other examples obtained by those of ordinary skill in the art based on the examples in the present application without creative work shall fall within the scope of protection of the present application.

In the following description, numerous details are given in order to provide a more thorough understanding of the present application. It will be apparent, however, to one skilled in the art that the present application may be practiced without one or more of these details. In other examples, some technical features well-known in the art are not described to avoid confusion with the present application; that is, not all features of the actual example are described here, and well-known functions and structures are not described in detail.

In the drawings, sizes and relative sizes of layers, regions and elements may be exaggerated for clarity. Like reference numerals denote like elements throughout.

It will be understood that when an element or layer is referred to as being “on,” “adjacent to,” “connected to” or “coupled to” other elements or layers, it can be directly on, adjacent to, connected to, or coupled to other elements or layers, or intervening elements or layers may be present. In contrast, when an element is referred to as being “directly on,” “directly adjacent to,” “directly connected to” or “directly coupled to” other elements or layers, there are no intervening elements or layers. It will be understood that, although the terms such as first, second, third etc. may be used to describe at least one of various elements, components, regions, layers or sections, at least one of these elements, components, regions, layers or sections should not be limited by these terms. These terms are only used to distinguish one element, component, region, layer or section from another element, component, region, layer or section. Thus, a first element, component, region, layer or section discussed below could be represented as a second element, component, region, layer or section without departing from the teachings of the present application. When a second element, component, region, layer or section is discussed, it does not indicate that a first element, component, region, layer or section exists in the present application.

The terminology used herein is for the purpose of describing particular examples only and is not to be taken as a limitation of the present application. As used herein, “a”, “an” and “said/the” in singular forms are intended to include the plural forms as well, unless the context clearly dictates otherwise. It should also be understood that at least one of the terms “consists of” or “including”, when used in this specification, identify the presence of at least one of stated features, integers, operations, elements or components, but do not exclude presence or addition of at least one of one or more other features, integers, operations, elements, components or groups. As used herein, the term “at least one of . . . ” includes any and all combinations of the associated listed items.

In order to understand the present application thoroughly, detailed operations and detailed structures will be proposed in the following description to set forth the technical solution of the present application. The detailed descriptions of the examples of the present application are as follows. However, the present application may also have other examples in addition to these detailed descriptions.

In the field of memory systems, for example, the field of solid-state drive (SSD) storage, a consumer-grade SSD stores personal data of a user, and an enterprise-grade SSD stores private information of a user, which is very important to both individuals and enterprises. However, in a case that firmware is corrupted or the firmware is upgraded with a new fault during the running of a device, the SSD faces a risk of a data loss. Therefore, the firmware is crucial to the SSD, and the prerequisite to ensure data security is to ensure the security of the firmware.

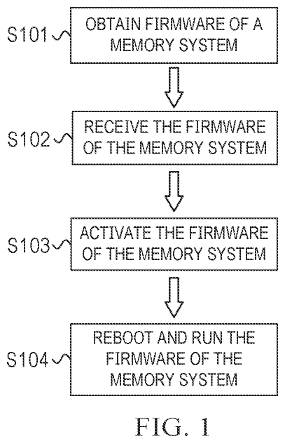

With reference to FIG. 1, a procedure of firmware upgrade of a memory system includes the following operations.

S101: obtain firmware of the memory system.

S102: receive the firmware of the memory system.

S103: activate the firmware of the memory system.

S104: reboot and run the firmware of the memory system.

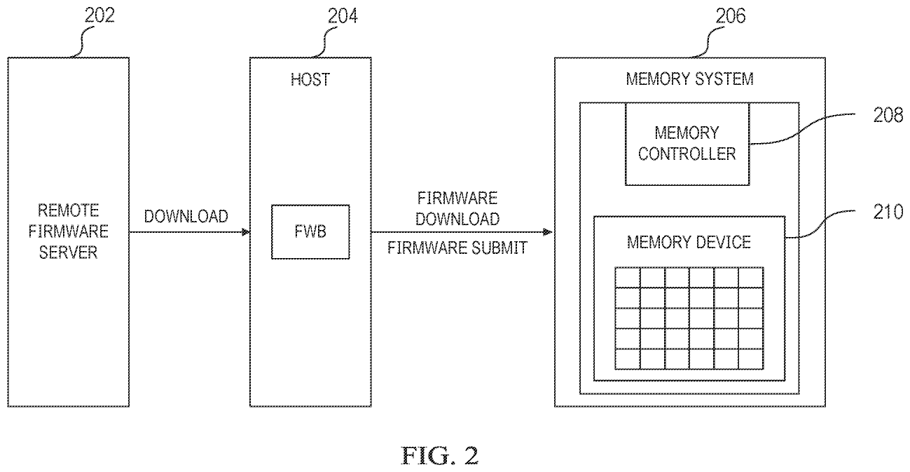

With reference to FIG. 2, the firmware upgrade of the memory system mainly involves a remote firmware server 202, a host 204, and a memory system 206. The memory system 206 includes a memory device 210 and a memory controller 208 coupled with the memory device 210.

In some examples, the remote firmware server 202 is coupled with a terminal having the host 204. In some examples, the terminal may include the memory system 206. A user may perform operations on the terminal to control the host to achieve various operations (for example, firmware upgrade operations), or, the terminal automatically triggers various operations (for example, firmware upgrade operations).

In some examples, the firmware may be a program that is stored in an electrically erasable programmable read-only memory (EEPROM) or a FLASH chip of the memory system 206 and can be upgraded by the host 204 through a refresh program. The firmware controls algorithms for reading/writing and transmission of the memory system 206 and allocates the data storage in a reasonable way. The memory system 206 stores relatively confidential information, therefore, it is critical to ensure the security of data and information stored in the memory system 206. One of the main effects of the firmware update is repairing BUGs in the memory system 206, thereby improving the quality and security of the memory system 206.

In some examples, the host 204 may establish a connection with the firmware server 202 through, for example, the TCP/IP protocol, send a firmware update request, and obtain a firmware update version (for example, first firmware FWB) sent in response to the firmware update request. Further, inside the host 204, the obtained firmware update file (for example, the first firmware FWB) may further be transmitted (by firmware downloading/firmware submission) to the memory system 206 through, for example, a high-speed serial computer extended bus standard (peripheral component interconnect express, PCIe) bus, and the firmware update file is decrypted and verified in the memory system 206 and the firmware update is achieved based on a target update file.

In some examples, in a case that the downloaded firmware (for example, the first firmware FWB) is damaged, the first firmware FWB is damaged in an activation process, or the first firmware FWB itself is faulty, etc., then there is a risk that the memory system firmware upgrade will be followed by a reboot to run the new firmware with a crash or a blue screen, and in severe cases, it will lead to the host 204 directly being bricked. For the user, the process of firmware upgrading to running the new firmware is exposed to the risk of losing data. Therefore, in this case, the importance of protecting the firmware or even the firmware upgrade and running the new firmware from causing the host 204 being bricked is self-evident. Herein and below, taking the memory system 206 as an example of the SSD for detailed description, but taking the memory system 206 as an example of the SSD is not intended to limit the embodiments of the present application.

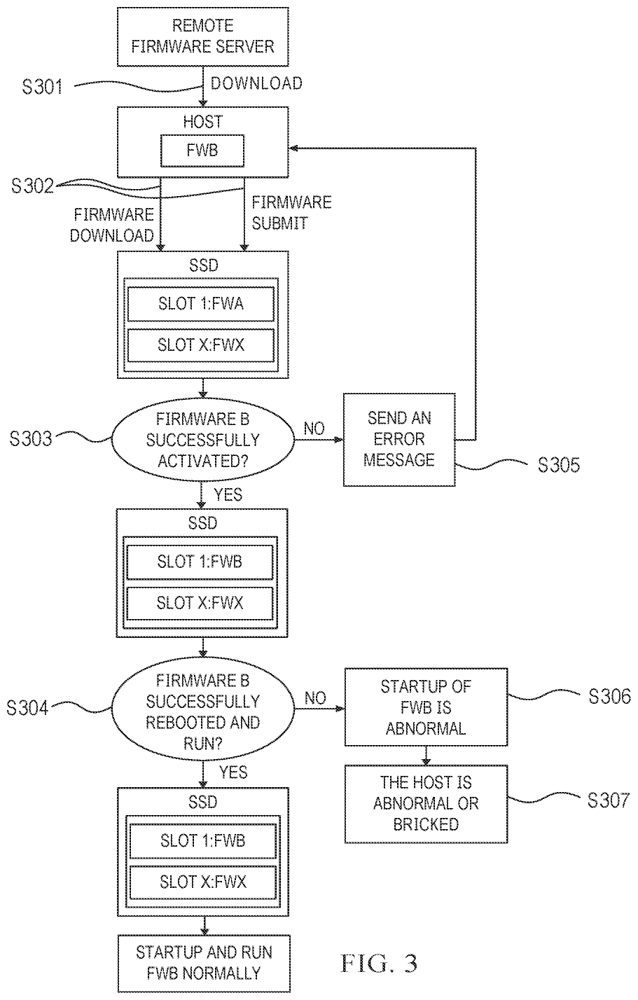

With reference to FIG. 2 and FIG. 3, in some examples, a main procedure of firmware upgrade of an SSD includes the following operations.

S301: the host obtains (or downloads) new firmware (taking the first firmware FWB as an example) of the SSD from the remote firmware server. Before the host downloads the first firmware FWB, firmware (taking second firmware FWA as an example) that is normally run by the memory system 206 before the firmware upgrade is stored in a first memory region (Slot1).

S302: the host sends (by firmware downloading/firmware submission) the first firmware FWB to the SSD.

S303: the host updates the firmware of the SSD, wherein if the first firmware FWB is successfully activated, the successfully activated first firmware FWB is stored in the first memory region Slot1.

If the first firmware FWB fails to be activated, Operation S305 is performed. In operation S305, send an error message to the host, wherein after the first firmware FWB is successfully activated, the first firmware FWB stored in the first memory region Slot1 may be run.

Operation S304 is performed. In operation S304, after the first firmware FWB is successfully activated, if the first firmware FWB is successfully rebooted and run, the first firmware FWB is still stored in the first memory region Slot1.

If the first firmware FWB fails to be rebooted and run, Operations S306 and S307 are performed.

Operation S306: startup of the first firmware FWB is abnormal.

Operation S307: the host is abnormal or bricked.

In some examples, it is specified to boot from the activated firmware of a certain memory region (e.g., the successfully activated first firmware FWB stored in the first memory region Slot1), and if a failure occurs or an error is injected into the firmware of that memory region, it will boot from the backup of the corresponding memory region, i.e., the firmware version remains unchanged. Download the firmware, update the activated firmware in a certain memory region (e.g., the successfully activated first firmware FWB stored in the first memory region Slot1) for boot up, if the firmware itself has a dead loop or is damaged, the host will be bricked, while the backup is also replaced by the corresponding damaged firmware, the host will not receive an AER (Advanced) Error Reporting) event indicating that the firmware upgrade to the new firmware is not successful.

Whether a process of activating and running the firmware of the SSD succeeds mainly depends on that the firmware is not damaged and the firmware does not have a problem, and at the same time, there is no error handling mechanism for running the firmware after firmware activation. Once the firmware fails to be switched and run, the user faces a risk of a data loss or even bricking. After the firmware is successfully activated, if switching to the new firmware for running fails, a computer is bricked, it is needed to contact a manufacturer or find professional personnel for repair. This affects the use and increases the labor and financial costs. The failure of the firmware switching running leads to bricking, which puts the user at risk of data loss.

In view of this, examples of the present application provide a memory system, an operation method thereof, a readable storage medium, and a system.

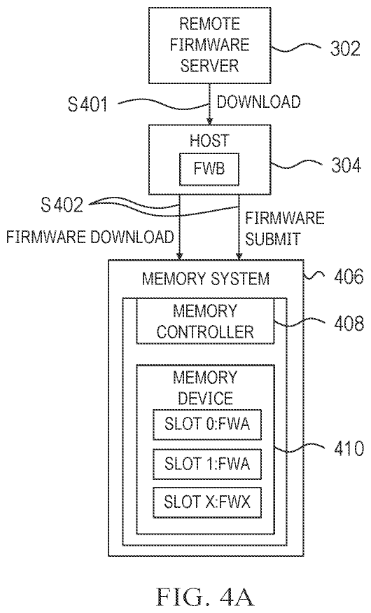

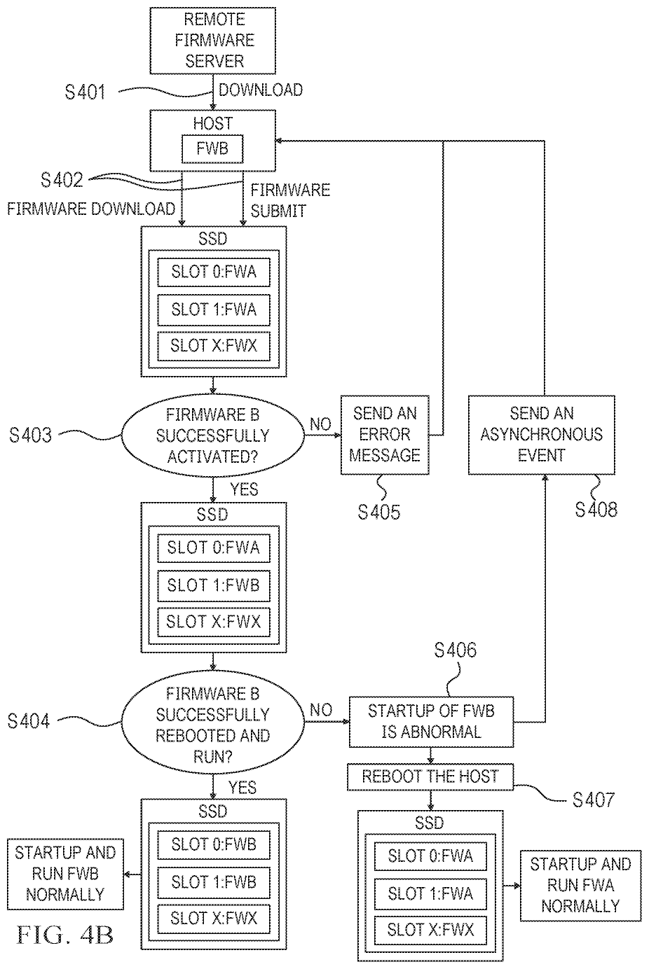

With reference to FIG. 4A and FIG. 4B, in a first aspect, examples of the present application provide a memory system 406. The memory system 406 includes a memory device 410 and a memory controller 408. The memory device 410 may include a first memory region Slot1 and a second memory region Slot0. The first memory region Slot1 is different from the second memory region Slot0. The memory controller 408 is coupled with the memory device 410. The memory controller 408 is configured to run second firmware FWA stored in the second memory region Slot0 when first firmware FWB stored in the first memory region Slot1 fails to be run. The first firmware FWB is firmware that is to be run by the memory system 406 after firmware upgrade, and the second firmware FWA is firmware that is normally run by the memory system 406 before the firmware upgrade. The memory controller is configured to replace the first firmware FWB stored in the first memory region Slot1 with the second firmware FWA.

It is to be noted that differences between the structure of the firmware update of the memory system shown in FIG. 4A and the structure of the firmware update of the memory system shown in FIG. 3 lie in at least that the memory device shown in FIG. 4A includes the second memory region Slot0 different from the first memory region Slot1 and the firmware in the second memory region Slot0 that is normally run by the memory system before the firmware upgrade. Differences between the working mode of the firmware update of the memory system shown in FIG. 4B and the working mode of the firmware update of the memory system shown in FIG. 3 lie in at least that the working mode of the firmware update of the memory system shown in FIG. 4B includes that, if specified firmware fails to be upgraded, for example, the error injection is performed, etc., it will boot from the firmware stored in the corresponding second memory region Slot0. If the firmware itself is damaged, after the firmware is successfully activated and fails to be switched and run, it will boot from the firmware stored in the hidden second memory region Slot0.

In some examples, a host 304 may be, for example, a personal computer, a mobile phone, a GPS terminal, and a digital satellite receiver, etc. In some examples, the memory controller 408 can manage data stored in the memory device 410. In some examples, the memory controller 408 is designed for operating in a low duty-cycle environment such as Secure Digital (SD) cards, Compact Flash (CF) cards, Universal Serial Bus (USB) flash drives, or other media for use in electronic devices, such as personal computers, digital cameras, mobile phones, etc. In some examples, the memory device 410 may be an device including a FLASH chip (for example, a three-dimensional NAND Flash memory). The FLASH chip may be used as a storage medium of the SSD of the above-mentioned memory system 406 to store data.

In the examples of the present application, when the first firmware stored in the first memory region Slot1 fails to be run, the second firmware stored in the second memory region Slot0 is run, and the first firmware FWB stored in the first memory region Slot1 is replaced with the second firmware FWA. In an example, if the first firmware FWB fails to be rebooted and run, Operations S406 and S407 are performed. In operation S406, startup of the first firmware FWB is abnormal. In operation S407, in a process of rebooting the host, it will boot from the firmware in the second memory region Slot0. That is, after the host is rebooted, the second firmware stored in the second memory region Slot0 FWA of the SSD is loaded and run. Because the second firmware FWA is the firmware that is normally run by the memory system 406 before the firmware upgrade, after the host is rebooted, the SSD can run normally. In the process of rebooting the host, after booting from the firmware in the second memory region Slot0, the second firmware stored in the second memory region Slot0 FWA is replaced with the first firmware FWB.

In the examples of the present application, by storing firmware that is normally run by a memory system before firmware upgrade in a second memory region, it is ensured that an intact firmware can be run. In an example, if the newly-upgraded firmware in a first memory region fails to be run, running the firmware stored in the second memory region and can be normally run, that is, firmware that is run intactly last time, ensures that the memory system is normally running in a process of firmware upgrading, avoids the possibility of a terminal where the memory system is located being bricked due to the failure in the process of running the newly-upgraded firmware, and safeguards the security of user data.

In some examples, the memory device includes a plurality of memory blocks, and the second memory region Slot0 is located in a memory block (code block) of the memory blocks that is configured to store code data.

In an example, a region in the memory block of the memory blocks that is configured to store code data is used as the second memory region Slot0 that is invisible to a user. The effect of the second memory region Slot0 is to back up a version of firmware that is being run currently, for example, the version of the firmware that is being run currently may be the firmware that is normally run by the memory system 406 before the firmware upgrade, or may be firmware that is to be run by the memory system 406 after the firmware upgrade and is run successfully after running.

In some examples, a plurality of regions in the memory block of the memory blocks that is configured to store code data may be configured to store firmware of different versions. In an example, there are a plurality of memory regions (a memory region SlotX generally refers to one of the plurality of memory regions) in the memory block of the memory blocks that is configured to store code data. The plurality of memory regions store firmware (firmware FWX generally refers to one of the firmware stored in the plurality of memory regions). In an example, a region in the memory block of the memory blocks that is configured to store code data is used as the first memory region Slot1. The effect of the first memory region Slot1 is to store successfully activated firmware in a process of the firmware upgrade. A plurality of regions in the memory block of the memory blocks that is configured to store code data are used as the third to eighth memory regions Slot2-Slot7. The effects of the third to eighth memory regions Slot2-Slot7 are to store firmware of different versions respectively. The memory system may select firmware in the first memory region Slot1, the second memory region Slot0, or one of the third to eighth memory regions Slot2-Slot7 according to an actual case for running. The number of memory regions in FIG. 4A and FIG. 4B may be 8. SlotX generally refers to one of the first to eighth memory regions, the firmware FWX generally refers to one of the firmware stored in the first to eighth memory regions, and two of the eight memory regions are the first memory region and second memory region respectively.

In the examples of the present application, a backup of the second memory region Slot0 is added to the memory block of the memory blocks that is configured to store code data. Although space of a code block is occupied and maintenance for data in the region is also added, a possibility that a terminal will not be bricked when a failure occurs in a process of activating firmware and switching and running new firmware is greatly ensured, thereby ensuring the security of user data.

In some examples, the memory controller is further configured to perform the following operations before the first firmware FWB stored in the first memory region Slot1 is run.

S401: the host obtains (or downloads) new firmware (taking the first firmware FWB as an example) of the SSD from the remote firmware server. Before the host downloads the first firmware FWB, firmware (taking the second firmware FWA as an example) that is normally run by the memory system 406 before the firmware upgrade is stored in both the first memory region Slot1 and a second memory region Slot0.

S402: the host sends (by firmware downloading/firmware submission) the first firmware FWB to the SSD.

S403: the host updates firmware of the SSD. If the first firmware FWB is successfully activated, the successfully activated first firmware FWB is stored in the first memory region Slot1.

If the first firmware FWB fails to be activated, Operation S405 is performed: send an error message to the host. After the first firmware FWB is successfully activated, the first firmware FWB stored in the first memory region Slot1 may be run.

In some examples, the host coupled with the memory system may establish a connection with the firmware server through, for example, the TCP/IP protocol, send a firmware update request, and obtain a firmware update version (for example, first firmware FWB) sent in response to the firmware update request. In some examples, the host may be, for example, a personal computer, a mobile phone, a GPS terminal, and a digital satellite receiver, etc.

In some examples, inside the host, the obtained firmware update file (for example, the first firmware FWB) may further be transmitted (by firmware downloading/firmware submission) to the memory system through, for example, a peripheral component interconnect express (PCIe, high-speed serial computer extended bus standard) bus, and the firmware update file is decrypted and verified in the memory system and the firmware update is achieved based on a target update file.

In some examples, the memory controller is configured to update the second firmware FWA stored in the first memory region Slot1 with the first firmware FWB before the first firmware FWB is run. The memory controller is further configured to send an error message when the update to the first firmware in the first memory region fails. The error message indicates an error state that the first firmware fails to be activated.

In an example, if the first firmware FWB fails to be activated, Operation S405 is performed. In operation S405, send an error message to the host. The error message indicates the error state that the first firmware fails to be activated.

In some examples, the memory controller is configured to update the second firmware FWA in the first memory region Slot1 with the first firmware FWB through a high-speed serial computer extended bus PCIe.

In some examples, the memory controller is configured to send an asynchronous event when the first firmware stored in the first memory region fails to be run. The asynchronous event includes at least a reason why the first firmware fails to be run after reboot.

In an example, if the first firmware FWB fails to be rebooted and run, Operations S406, S407, and S408 are performed. In operation S406, startup of the first firmware FWB is abnormal. In operation S407, in a process of rebooting the host, it will boot from the firmware in the second memory region Slot0. That is, after the host is rebooted, the second firmware stored in the second memory region Slot0 FWA of the SSD is loaded and run. Because the second firmware FWA is the firmware that is normally run by the memory system 406 before the firmware upgrade, after the host is rebooted, the SSD can run normally. In operation S408, after booting from the firmware in the second memory region Slot0 in the process of rebooting the host, send an asynchronous event to the host. The asynchronous event includes at least a reason why the first firmware fails to be run after reboot.

In some examples, the memory controller is configured to replace the second firmware stored in the second memory region with the first firmware when the first firmware stored in the first memory region is run successfully.

In an example, Operation S404 is performed. In operation S404, after the first firmware FWB is successfully activated, if the first firmware FWB is successfully rebooted and run, the second firmware FWA stored in the first memory region Slot1 is replaced with the first firmware FWB.

In some examples, one variable is used to record a current firmware running state of the memory system, as shown in the following Table 1. The memory controller obtains a firmware running state of the memory system through a ROM, and performs firmware of a memory region according to the firmware running state.

TABLE 1

| Variable | Value | Notes |
|---|---|---|
| act_state | 0 | Default, ROM mode phase |
| | 1 | Jump to a new firmware |
| | | phase |
| | 2 | Firmware is run |
| | | successfully |

In an example, when the firmware running state is in a first state, that is, a value of the variable act_state is 2, the memory controller loads firmware in a specified memory region for running. The firmware in the specified memory region may be the firmware that is normally run by the memory system 406 before the firmware upgrade, or may be firmware that is to be run by the memory system 406 after the firmware upgrade and is run successfully after running. When the firmware running state is in a second state, the value of the variable act_state is 1, and the memory controller switches to the firmware of the second memory region Slot0 for running. When the firmware running state is in a third state, the value of the variable act_state is 0, and the memory controller loads firmware of a default memory region for running. The firmware of the default memory region may be the firmware of the first memory region Slot1.

In some examples, the memory controller is configured to obtain a firmware running state of the memory system after the memory system is rebooted. The memory controller is configured to update the firmware running state from a first state to a second state and run the first firmware in the first memory region when the firmware running state is in the first state. The memory controller is further configured to update the firmware running state from the second state to the first state and update the second firmware stored in the second memory region with the first firmware when the first firmware is run successfully.

In some examples, the memory controller further includes a read-only memory (ROM), and the memory controller is configured to: after the memory system is rebooted, a firmware running state of the memory system can be obtained through the ROM. The ROM includes program codes for detecting the firmware running state, and the firmware running state of the memory system is obtained through the program codes.

In an example, through the reboot, the ROM reads the value of the variable act_state. If the value of the variable act_state is 2, the ROM then jumps to successfully activated firmware stored in the first memory region Slot1, at the same time updates the value of the variable act_state to 1, and directly loads the successfully activated firmware stored in the specified first memory region Slot1. After the successfully activated firmware is run successfully, the value of the variable act_state is updated to 2, and at the same time, hidden firmware (or firmware invisible to the user) in the second memory region Slot0 is updated with firmware (firmware that is successfully activated and run) that is being run currently.

In some examples, the memory controller is configured to keep the firmware running state in the second state when the first firmware fails to be run. The memory controller is further configured to re-obtain the firmware running state of the memory system after the memory system is rebooted again, and run the second firmware of the second memory region when the firmware running state is in the second state. The memory controller is further configured to update the firmware running state from the second state to the first state and update the first firmware stored in the second memory region with the second firmware when the second firmware of the first memory region is run successfully.

In an example, through the reboot, the ROM reads the value of the variable act_state. If the value of the variable act_state is 2, the ROM then jumps to successfully activated firmware, and at the same time, updates the value of the variable act_state to 1, and directly loads the successfully activated firmware stored in the specified first memory region Slot1. After the successfully activated firmware fails to be run, the value of the variable act_state is still 1, and the firmware is in a stuck state after failing to be run. Through the reboot, the ROM reads the value of the variable act_state. If the value of the variable act_state is 1, the ROM then jumps to the firmware that is stored in the second memory region Slot0 and is normally run by the memory system before the firmware upgrade, and at the same time, updates the value of the variable act_state to 1, and directly loads the firmware that is stored in the specified second memory region Slot0 and is normally run by the memory system before the firmware upgrade. When the firmware stored in the second memory region Slot0 is run successfully, at the same time, the value of the variable act_state is updated to 2.

In some examples, the memory controller is configured to run the second firmware in the second memory region when the firmware running state is in a third state.

In some examples, when the firmware upgrade command is not received, cause the firmware running state to be in the third state by default; and when the firmware upgrade command is received, cause the firmware running state to be in the first state by default.

In an example, when the firmware upgrade command is not received, the firmware running state is in the third state by default. Through the reboot, the ROM reads the value of the variable act_state, and if the value of the variable act_state is 0, the ROM then jumps by default to the firmware that is in the first memory region Slot1 and is normally run by the memory system before the firmware upgrade. When the firmware upgrade command is received, the firmware running state is in the first state by default. Through the reboot, the ROM reads the value of the variable act_state. If the value of the variable act_state is 1, the ROM then jumps to the firmware that is stored in the second memory region Slot0 and is normally run by the memory system before the firmware upgrade, and at the same time, updates the value of the variable act_state to 1, and directly loads the firmware that is stored in the specified second memory region Slot0 and is normally run by the memory system before the firmware upgrade.

In some examples, after a process of rebooting and switching to the new firmware fails, and when the reboot is booted from the firmware stored in the second memory region Slot0, an AER event is generated, to actively inform the host of a reason why the new firmware fails to be switched and run and therefore the firmware is rolled back to a version of firmware that is run a previous time.

In some examples, if the firmware fails to be activated, state information of an error is returned to the host.

In a second aspect, examples of the present application provide an operation method of a memory system. The method includes running second firmware stored in a second memory region in a memory device of the memory system when first firmware stored in a first memory region in the memory device fails to be run. The first firmware is firmware that is to be run by the memory system after firmware upgrade. The second firmware is firmware that is normally run by the memory system before the firmware upgrade. The first memory region is different from the second memory region. The method further includes replacing the first firmware stored in the first memory region with the second firmware.

In some examples, the method further includes sending an asynchronous event when the first firmware stored in the first memory region fails to be run. The asynchronous event includes at least a reason why the first firmware fails to be run after reboot.

In some examples, the method further includes replacing the second firmware stored in the second memory region with the first firmware when the first firmware stored in the first memory region is run successfully.

In some examples, the method further includes obtaining a firmware running state of the memory system after the memory system is rebooted. The method further includes updating the firmware running state from a first state to a second state and running the first firmware in the first memory region when the firmware running state is in the first state. The method further includes updating the firmware running state from the second state to the first state and updating the second firmware stored in the second memory region with the first firmware when the first firmware is run successfully.

In some examples, the method further includes keeping the firmware running state in the second state when the first firmware fails to be run; re-obtaining the firmware running state of the memory system after the memory system is rebooted again, and running the second firmware of the second memory region when the firmware running state is in the second state; and updating the firmware running state from the second state to the first state and updating the first firmware stored in the second memory region with the second firmware when the second firmware of the first memory region is run successfully.

In some examples, the method further includes running the second firmware in the second memory region when the firmware running state is in the third state.

In some examples, the memory device includes a plurality of memory blocks, and the second memory region is located in a memory block of the memory blocks that is configured to store code data.

In some examples, the method further includes updating the second firmware stored in the first memory region to the first firmware before the first firmware is run; and sending an error message when the update with the first firmware in the first memory region fails. The error message indicates an error state that the first firmware fails to be activated.

In some examples, the method further includes updating the second firmware in the first memory region with the first firmware through a PCIe.

The memory system used in the operation method of the memory system provided by various examples of the second aspect of the present application is the same as or similar to the memory system in the above examples of the first aspect. The technical features not disclosed exhaustively in the examples of the present application may be understood with reference to the memory system in the above examples of the first aspect, and are no longer repeated.

In a third aspect, examples of the present application provide a readable storage medium, having a computer program stored therein which, when being executed, implements the operation method of the memory system of any one of the examples of the second aspect. The method includes running second firmware stored in a second memory region in a memory device of the memory system when first firmware stored in a first memory region in the memory device fails to be run. The first firmware is firmware that is to be run by the memory system after firmware upgrade. The second firmware is firmware that is normally run by the memory system before the firmware upgrade. The first memory region is different from the second memory region. The method further includes replacing the first firmware stored in the first memory region with the second firmware.

In a fourth aspect, examples of the present application provide a system 500. The system 500 includes a host 508 and a memory system 502 coupled with the host 508. The host 508 is configured to send a firmware upgrade command to the memory system 502. The memory system 502 is configured to in response to the firmware upgrade command, run second firmware stored in a second memory region of the memory system when first firmware stored in a first memory region of the memory system fails to be run. The first firmware is firmware that is to be run by the memory system after firmware upgrade. The second firmware is firmware that is normally run by the memory system before the firmware upgrade. The memory system 502 is further configured to replace the first firmware stored in the first memory region with the second firmware. The memory system 502 is further configured to send an asynchronous event when the first firmware stored in the first memory region fails to be run. The asynchronous event includes at least a reason why the first firmware fails to be run after reboot.; The memory system 502 is further configured to replace the second firmware stored in the second memory region with the first firmware when the first firmware stored in the first memory region is run successfully.

In some examples, the host 508 is configured to: download the first firmware from a server and send the downloaded first firmware to the memory system before the memory system runs the first firmware; and the memory system 502 is configured to: activate the first firmware, and update with the first firmware in the first memory region when the first firmware is successfully activated; and send an error message to the host when the first firmware fails to be activated. The error message indicates an error state that the first firmware fails to be activated.

In some examples, the memory system 502 is configured to: when the firmware upgrade command of the host is not received, cause the firmware running state to be in the third state by default; and when the firmware upgrade command of the host is received, cause the firmware running state to be in the first state by default.

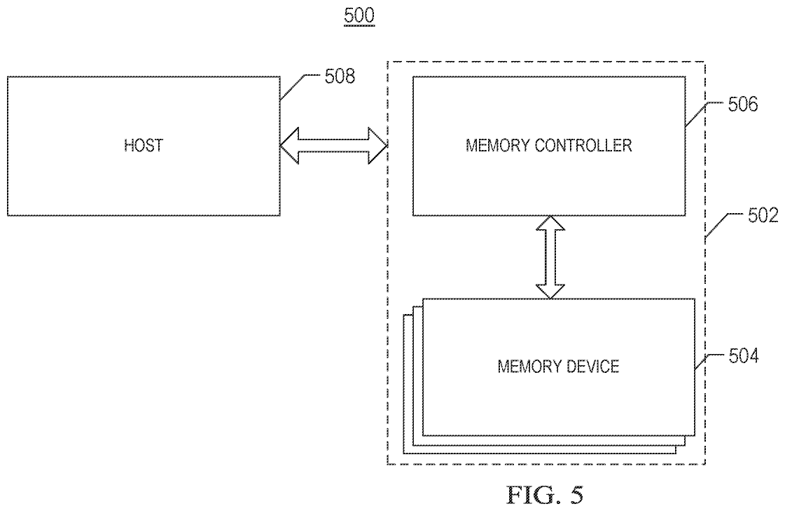

FIG. 5 shows a block diagram of an example system 500 having a memory according to some aspects of the present application. The system 500 may be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 5, system 500 can include a host 508 and a memory system 502 having one or more memory devices 504 and a memory controller 506. Host 508 can be a processor of an electronic device, such as a central processing unit (CPU), or a system-on-chip (SoC), such as an application processor (AP). Host 508 can be configured to send or receive data to or from the memory device 504.

The memory device 504 may be any memory disclosed in the present disclosure. As disclosed below in detail, the memory devices 504, e.g., NAND flash memories (such as, three-dimensional (3D) NAND flash memories), may have a reduced leakage current from a drive transistor (e.g., a string driver) coupled to unselected word lines during erase operations, which allows for further reduction of the size of the drive transistor.

Memory controller 506 is coupled to the memory device 504 and host 508 and is configured to control the memory device 504, according to some examples. Memory controller 506 can manage the data stored in memory device 504 and communicate with host 508. In some examples, memory controller 506 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some examples, memory controller 506 is designed for operating in a high duty-cycle environment SSD or embedded multi-media-cards (eMMC) used as data storage for mobile devices, such as smartphones, tablets, laptop computers, etc., and enterprise storage arrays.

Memory controller 506 can be configured to control operations of the memory device 504, such as read, erase, and program operations. Memory controller 506 can also be configured to manage various functions with respect to the data stored or to be stored in the memory device 504 including, but not limited to bad-block management, garbage collection, logical-to-physical address conversion, wear leveling, etc. In some examples, memory controller 506 is further configured to process error correction codes (ECC) with respect to the data read from or written to the memory device 504. Any other suitable functions may be performed by memory controller 506 as well, for example, formatting the memory device 504. Memory controller 506 can communicate with an external device (e.g., host 508) according to a particular communication protocol. For example, memory controller 506 may communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

Memory controller 506 and one or more memory devices 504 can be integrated into various types of storage devices, for example, be included in the same package, such as a universal Flash storage (UFS) package or an eMMC package. That is, memory system 502 can be implemented and packaged into different types of end electronic products.

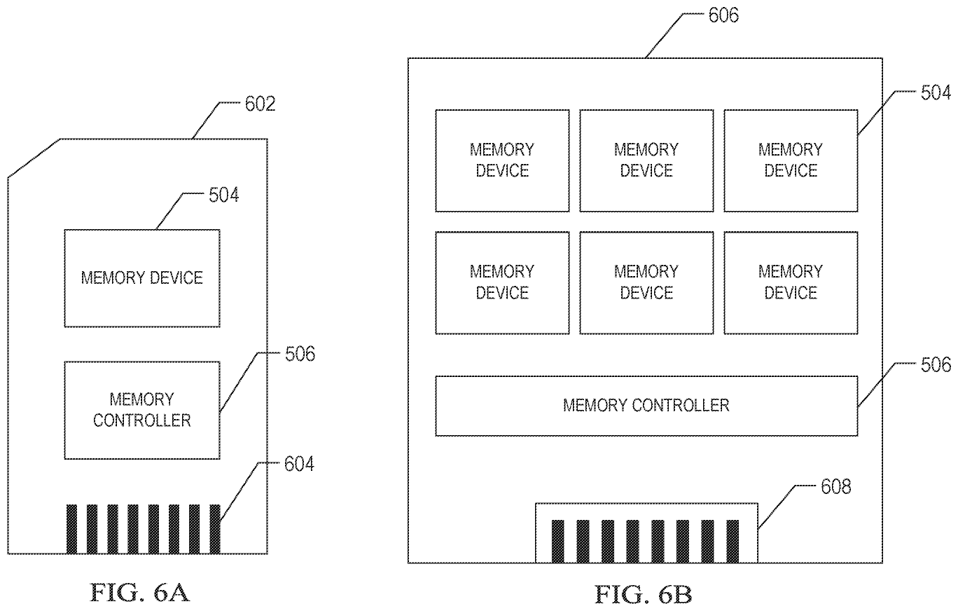

In one example as shown in FIG. 6A, memory controller 506 and a single memory device 504 may be integrated into a memory card 602. Memory card 602 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 602 can further include a memory card connector 604 coupling the memory card 602 with a host (e.g., host 508 in FIG. 5).

In another example as shown in FIG. 6B, the memory controller 506 and multiple memory devices 504 may be integrated into an SSD 606. SSD 606 can further include an SSD connector 608 coupling SSD 606 with a host (e.g., host 508 in FIG. 5). In some examples, at least one of the storage capacity or the operation speed of SSD 606 is greater than those of memory card 602.

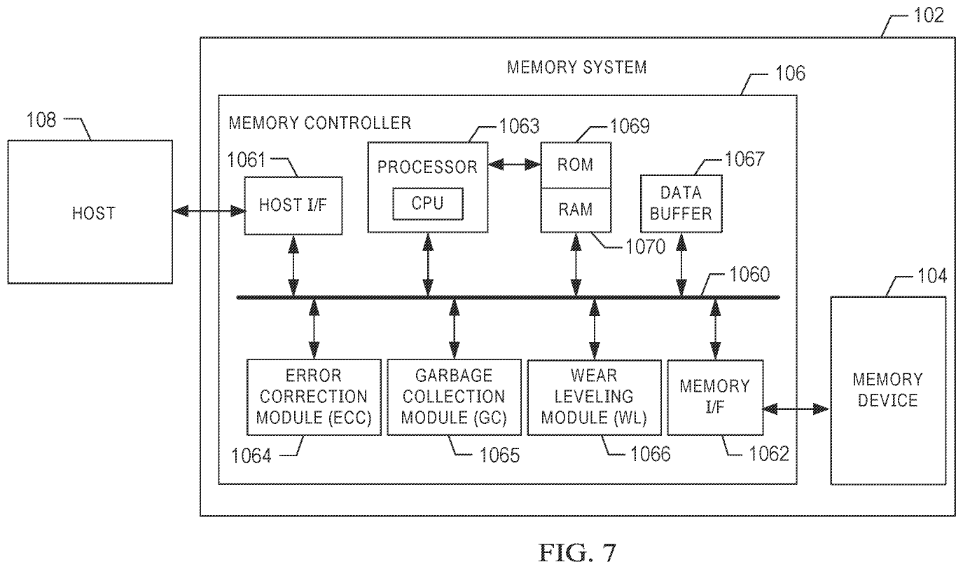

With reference to FIG. 7, in some examples, the memory system 102 is coupled to the host, and performs various feedback operations in response to instructions of the host. The memory system 102 may include a memory controller 106 and a memory device 104. The memory controller 106 is configured to control the memory device 104 to perform operations such as read, write, erase, etc. The memory controller 106 may also be coupled the memory device 104 in any appropriate manner.

The memory controller 106 may include a host interface (I/F) 1061, a memory interface (I/F) 1062, a processor 1063, a read-only memory (ROM) 1069, a random access memory (RAM) 1070, an error correction module 1064, a garbage collection module 1065, a wear leveling module 1066, a data buffer 1067, and a bus 1060. The host interface 1061 is a connection interface for a connection between a host 108 and the memory controller 106. The host interface 1061 allows the host to communicate with the memory controller according to a particular protocol, send read and write requests, and perform other operations. The memory interface 1062 is a connection interface between the memory controller 106 and the memory device 104. The memory interface 1062 is configured to enable data transmission between the memory controller 106 and the memory device 104. The processor 1063 is configured to control the memory system 102 as a whole. The foregoing operations performed by the memory controller are mainly performed and completed by the processor 1063 here. In some examples, the processor 1063 is, for example, a central processing unit (CPU), a microcontroller unit (MCU), etc. The ROM 1069 includes firmware or firmware program codes of the memory controller 106. These codes are used for initializing and operating various components of the memory controller, and the RAM 1070 is configured to buffer data. The error correction module 1064 may further include an encoding unit and a decoding unit. The encoding unit is configured to encode data to be stored to obtain check data, and the decoding unit is configured to decode the check data to detect and correct possible error data in a process of data transmission.

The garbage collection module 1065 is configured to: after a storage space of the memory device reaches a certain threshold, read out valid data in some memory blocks, perform rewrite, and then label these memory blocks, to obtain new spare memory blocks. An example of garbage collection may include three operations: selecting a source memory block with a small amount of valid data; finding the valid data from the source memory block; and writing the valid data to a target memory block. In this case, all data in the source memory block becomes invalid data, and the source memory block is labeled, and may be used as a new spare memory block. The wear leveling module 1066 is configured to level wear (the number of erase times) of each memory block in the memory system through data statistics and algorithms. An example of wear leveling may include two operations: selecting a source memory block in which cold data is located; and reading valid data in the source memory block and writing the valid data in a memory block with a relatively large number of erase times. In this case, the valid data in the source memory block becomes invalid data, and the source memory block is labeled. The buffer 1067 is configured to buffer data.

The memory device 104 and the memory block may be understood with reference to the structure and working mode of the foregoing memory device 104, and details are not described again herein.

It is to be understood that, references to “an example” and “some examples” throughout this specification mean that particular features, structures, or characteristics related to the one or more examples are included in at least one example of the present application. Therefore, “in an example” and “in some examples” appearing everywhere in the entire specification does not refer to the same example. Furthermore, these particular features, structures, or characteristics may be incorporated in one or more examples in any suitable manner. It is to be understood that, in various examples of the present application, sequence numbers of the above processes do not indicate an execution order, and an execution order of various processes shall be determined by functionalities and intrinsic logics thereof, and shall constitute no limitation on an implementation process of the examples of the present application. The above sequence numbers of the examples of the present application are only for description, and do not represent advantages or disadvantages of the examples.

The above descriptions are merely preferred implementations of the present application, and not intended to limit the patent scope of the present application. Equivalent structure transformation made within using the contents of the specification and the drawings of the present application under the inventive concept of the present application, or direct/indirect application to other related technical fields are both encompassed within the patent protection scope of the present application.

What is claimed is:

1. A memory system, comprising:
a memory device, comprising a first memory region and a second memory region, wherein the first memory region is different from the second memory region; and
a memory controller, coupled with the memory device and configured to:
run second firmware stored in the second memory region when first firmware stored in the first memory region fails to be run, wherein the first firmware is firmware that is to be run by the memory system after firmware upgrade, and the second firmware is firmware that is normally run by the memory system before the firmware upgrade; and
replace the first firmware stored in the first memory region with the second firmware.

2. The memory system of claim 1, wherein the memory controller is configured to:
send an asynchronous event when the first firmware stored in the first memory region fails to be run, wherein the asynchronous event comprises at least a reason why the first firmware fails to be run after reboot.

3. The memory system of claim 1, wherein the memory controller is configured to:
replace the second firmware stored in the second memory region with the first firmware when the first firmware stored in the first memory region is run successfully.

4. The memory system of claim 3, wherein the memory controller is configured to:
obtain a firmware running state of the memory system after the memory system is rebooted;
update the firmware running state from a first state to a second state and run the first firmware in the first memory region when the firmware running state is in the first state; and
update the firmware running state from the second state to the first state and update the second firmware stored in the second memory region with the first firmware when the first firmware is run successfully.

5. The memory system of claim 4, wherein the memory controller is configured to:
keep the firmware running state in the second state when the first firmware fails to be run;
re-obtain the firmware running state of the memory system after the memory system is rebooted again, and run the second firmware of the second memory region when the firmware running state is in the second state; and
update the firmware running state from the second state to the first state and update the first firmware stored in the second memory region with the second firmware when the second firmware of the first memory region is run successfully.

6. The memory system of claim 1, wherein the memory device comprises memory blocks, and the second memory region is located in a memory block of the memory blocks that is configured to store code data.

7. The memory system of claim 1, wherein the memory controller is configured to:
update the second firmware stored in the first memory region with the first firmware before the first firmware is run; and
send an error message when the update with the first firmware in the first memory region fails, wherein the error message indicates an error state that the first firmware fails to be activated.

8. The memory system of claim 7, wherein the memory controller is configured to:
update the second firmware in the first memory region with the first firmware through a high-speed serial computer extended bus PCIe.

9. The memory system of claim 1, wherein the memory system comprises a solid state drive (SSD).

10. A method of operating a memory system, comprising:
running second firmware stored in a second memory region in a memory device of the memory system when first firmware stored in a first memory region in the memory device fails to be run, wherein the first firmware is firmware that is to be run by the memory system after firmware upgrade, the second firmware is firmware that is normally run by the memory system before the firmware upgrade, and the first memory region is different from the second memory region; and
replacing the first firmware stored in the first memory region with the second firmware.

11. The method of claim 10, further comprising:
sending an asynchronous event when the first firmware stored in the first memory region fails to be run, wherein the asynchronous event comprises at least a reason why the first firmware fails to be run after reboot.

12. The method of claim 10, further comprising:
replacing the second firmware stored in the second memory region with the first firmware when the first firmware stored in the first memory region is run successfully.

13. The method of claim 12, further comprising:
obtaining a firmware running state of the memory system after the memory system is rebooted;
updating the firmware running state from a first state to a second state and running the first firmware in the first memory region when the firmware running state is in the first state; and
updating the firmware running state from the second state to the first state and updating the second firmware stored in the second memory region with the first firmware when the first firmware is run successfully.

14. The method of claim 13, further comprising:
keeping the firmware running state in the second state when the first firmware fails to be run;
re-obtaining the firmware running state of the memory system after the memory system is rebooted again, and running the second firmware of the second memory region when the firmware running state is in the second state; and
updating the firmware running state from the second state to the first state and updating the first firmware stored in the second memory region with the second firmware when the second firmware of the first memory region is run successfully.

15. The method of claim 10, wherein the memory device comprises memory blocks, and the second memory region is located in a memory block of the memory blocks that is configured to store code data.

16. The method of claim 10, further comprising:
updating the second firmware stored in the first memory region with the first firmware before the first firmware is run; and
sending an error message when the update with the first firmware in the first memory region fails, wherein the error message indicates an error state that the first firmware fails to be activated.

17. The method of claim 16, further comprising:
updating the second firmware in the first memory region with the first firmware through a PCIe.

18. A system, comprising:
a host, configured to:
send a firmware upgrade command to a memory system; and
the memory system, coupled with the host and configured to:
in response to the firmware upgrade command, run second firmware stored in a second memory region of the memory system when first firmware stored in a first memory region of the memory system fails to be run wherein the first firmware is firmware that is to be run by the memory system after firmware upgrade, and the second firmware is firmware that is normally run by the memory system before the firmware upgrade; and
replace the first firmware stored in the first memory region with the second firmware;
send an asynchronous event when the first firmware stored in the first memory region fails to be run, wherein the asynchronous event comprises at least a reason why the first firmware fails to be run after reboot; and
replace the second firmware stored in the second memory region with the first firmware when the first firmware stored in the first memory region is run successfully.

19. The system of claim 18, wherein
the host is configured to:
download the first firmware from a server and send the downloaded first firmware to the memory system before the memory system runs the first firmware; and
the memory system is configured to:
activate the first firmware, and update with the first firmware in the first memory region when the first firmware is successfully activated; and
send an error message to the host when the first firmware fails to be activated, wherein the error message indicates an error state that the first firmware fails to be activated.

20. The system of claim 18, wherein the memory system comprises a solid state drive (SSD).
